(19) United States
(12) Patent Application Publication
(10) Pub. No.: US 2016/0287363 A1
(43) Pub. Date: Oct. 6, 2016

(54) Instructional Toothbrush

(71) Applicant: Lynnda Miller, Brighton, CO (US)

(72) Inventor: Lynnda Miller, Brighton, CO (US)

(21) Appl. No.: 15/087,356

(22) Filed: Mar. 31, 2016

Related U.S. Application Data
(60) Provisional application No. 62/141,912, filed on Apr. 2, 2015.

(51) Int. Cl. A61C 17/22; A61C 17/34; A46B 5/00; A46B 15/00; A46B 9/04

(52) U.S. Cl. CPC A61C 17/221; A46B 15/0042; A46B 15/0008; A46B 9/04; A46B 5/0095; A61C 17/3409

(57) ABSTRACT

An instructional, electronic toothbrush having an audio unit with a speaker for playing audio stored on a storage medium. The audio unit is operably coupled to a song playing system positioned in an interior compartment within the toothbrush. The system includes a computer processing unit (CPU) having a memory configured to store an instructional song that teaches the proper technique when brushing teeth. When a power switch is actuated on the toothbrush, the CPU relays the song stored on the memory to the speaker, which sounds the instructional song repetitively. A timer operably coupled to the audio unit stops the speaker from sounding the instructional song once two minutes have elapsed. In this way, children brushing their teeth to the instructional song using the present instructional toothbrush can be provided guidance on how to properly brush their teeth for the American Dental Association's recommended time period of two minutes.

### CROSS REFERENCE TO RELATED APPLICATIONS

This application claims the benefit of U.S. Provisional Application No. 62/141,912 filed on Apr. 2, 2015. The above identified patent application is herein incorporated by reference in its entirety to provide continuity of disclosure.

### BACKGROUND OF THE INVENTION

The present invention relates to electric toothbrushes. More specifically, the present invention relates to interactive and audio toothbrushes for instructing users as to the proper technique while brushing their teeth.

Toothbrushes are necessary oral hygiene devices meant for keeping individuals' mouths free from cavities, odor, and disease. However, the majority of individuals, particularly children, do not brush their teeth for the American Dental Association's recommended two minutes. Moreover, the majority of children do not brush their teeth using the appropriate technique—that is, brushing all sides and surfaces of their teeth in a back and forth motion in short strokes, while applying gentle pressure throughout. This stems from the fact that children usually view brushing their teeth as boring and a bothersome task. Because of their young age, children do not understand the importance of brushing their teeth and tend to take for granted the significance of brushing their teeth for the full two minutes with the appropriate technique. For instance, while brushing their teeth, children have a habit of limiting their brushing to certain areas of their mouth and applying too much pressure on their teeth, thereby hurting their gums. It is crucial to teach children the proper technique when brushing their teeth. Therefore, there is a need for an improved electric toothbrush having an audio unit configured to sound an instructional song for a full two minutes that teaches children the proper technique when brushing their teeth.

Devices have been disclosed in the prior art that relate to educational and musical toothbrushes. These include toothbrushes that have been patented and published in patent application publications. These devices generally relate to toothbrushes comprising a storage medium capable of storing and playing audio information. The following is a list of devices deemed most relevant to the present disclosure, which are herein described for the purposes of highlighting and differentiating the unique aspects of the present invention, and further highlighting the drawbacks existing in the prior art.

U.S. Pat. Nos. 6,154,912 to Li (hereinafter “Li”), 7,418,757 to Gatzerneyer (hereinafter “Gatzerneyer”), 7,845,041 to Gatzemeyer (hereinafter “Gatzemeyer”), 8,387,195 to Patel (hereinafter “Patel”), and U.S. Patent Application Pub. No. 2010/0047750 to King (hereinafter “King”) all disclose an electric toothbrush having a speaker configured to emit audio sound. Li discloses a speaker integral to the handle of the toothbrush, Gatzerneyer and Gatzemeyer disclose a speaker positioned within a storage unit that is removably attachable to the handle of the toothbrush, King discloses a resonance box having a speaker configured to receive the toothbrush, and Patel discloses a toothbrush comprising a body having a speaker that is configured to removably receive the toothbrush neck and head. Further, Patel discloses a toothbrush configured to automatically deactivate after a two-minute time instructional period elapses. Although, the aforementioned electrical toothbrushes are similar in nature and relevant to the present invention they differ in that they fail to provide an electrical toothbrush having a timer configured to stop the audio unit from sounding an instructional song after a two minute period has elapsed.

The present invention provides an electric toothbrush having an audio unit including one or more speakers. The audio unit is operably coupled to a song playing system disposed in an interior compartment of the toothbrush. The song playing system includes a computer processing unit (CPU) having a storage medium or memory configured to store an instructional song that teaches a brusher the proper tooth brushing technique. When a power switch is actuated on the toothbrush, the CPU relays the instructional song stored on the memory to the audio unit, wherein the speaker sounds the instructional song repetitively. A timer coupled to the song playing system stops the audio unit from sounding the instructional song once a predetermined period of time has elapsed, such as two minutes. In this way, children brushing their teeth to the instructional song using the present instructional toothbrush can be provided guidance on how to properly brush their teeth for the ADA recommended time period of two minutes and further directed to stop brushing their teeth after two minutes.

In view of the drawbacks of the prior art devices, it is shown that the prior art has several known setbacks and that the present invention is substantially divergent in design element from the prior art and subsequently it is clear that there is a need in the art for an improvement to musical or educational toothbrushes. In this regard, the instant invention substantially fulfills these needs.

### SUMMARY OF INVENTION

In view of the foregoing disadvantages inherent in the known types of musical or educational toothbrushes now present in the prior art, the present invention provides an instructional toothbrush wherein the same can be utilized for providing convenience for children when learning how to properly brush their teeth for the ADA recommended two minute time period. The present invention comprises an instructional toothbrush comprising a handle integrally affixed to a brush neck, thereby forming a water-impermeable toothbrush, a power source, a power switch configured to activate the power source, a brush head affixed to the brush neck, wherein the brush head includes moveable tooth cleaning bristles thereon, an actuator configured to drive the brush head upon activation of the power source, and an interior compartment positioned within the toothbrush having an audio unit configured to sound an instructional song upon actuation of the power source, a computer processing unit having a memory configured to store the instructional song thereon, wherein the computer processing unit is coupled to the audio unit and configured to relay the instructional song to the audio unit upon activation of the power source, a timer operably coupled to the computer processing unit, wherein the timer is configured to activate upon actuation of the power source, and wherein the timer is further configured to stop the audio unit after a certain amount of predetermined time has lapsed.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective and partial phantom view of the instructional toothbrush and docking station according to one embodiment of the present invention.

FIG. 2 shows a diagram illustrating the relationship in between the power switch and brush head according to one embodiment of the present invention.

FIG. 3 shows a flow chart illustrating the actuation of the brush head according to one embodiment of the present invention.

FIG. 4 shows a rear perspective and partial cross-sectional view of the instructional toothbrush according to one embodiment of the present invention.

FIG. 5 shows a diagram illustrating the song playing system of the instructional toothbrush according to one embodiment of the present invention.

### DETAILED DESCRIPTION OF THE INVENTION

Reference is made herein to the attached drawings. Like reference numerals are used throughout the drawings to depict like or similar elements of the instructional toothbrush. The figures are intended for representative purposes only and should not be considered to be limiting in any respect.

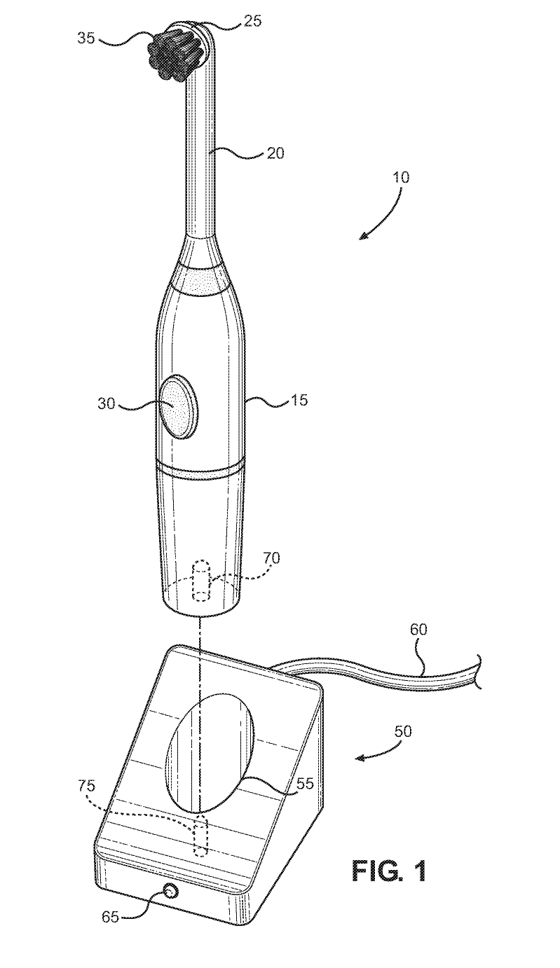

Referring now to FIG. 1, there is shown a front perspective view of the instructional toothbrush and docking station according to one embodiment of the present invention. The present invention comprises an electric toothbrush 10, having a handle 15, a brush neck 20, a brush head 25, and a power switch 30. The brush head 25 comprises moveable tooth cleaning bristles 35 and is affixed to the brush neck 20. The tooth cleaning bristles 35 are moveable insofar as they are configured to rotate when the brush head 25 is driven by an actuator, such that they may clean teeth when applied thereto. In the depicted embodiment, the brush head 25 is integral to the toothbrush 10 and is moveable in a rotational direction relative to the brush neck 20. However, in alternative embodiments, the brush head 25 is removably affixable to the brush neck 20, such that a user may remove and replace the brush head 25 once the tooth cleaning bristles 35 are frayed or worn.

The toothbrush 10 further comprises a power source configured to supply power to an actuator and drive the brush head 25. Preferably, the power source is a rechargeable battery that is rechargeable by a docking station 50 having a receptacle 55 sized to receive the toothbrush handle 15. In the depicted embodiment, the docking station 50 comprises a power cord 60 connectable to a wall outlet that supplies power to the docking station 50 and charges the toothbrush 10 once the handle 15 is inserted into the receptacle 55. The docking station 50 further comprises a power light 65 that indicates that the docking station 50 is receiving power. In one embodiment, the receptacle 55 comprises a connector 75 at its base and the handle 15 comprises a port 70 at its bottom, which is configured to receive the connector 75 and establish an electrical connection therebetween. In operation, once a connection is established between the connector 75 and port 70, and the docking station's 50 power cord 60 is plugged into a wall outlet, the electric toothbrush 10 begins to charge. In another embodiment, the docking station 50 is a wireless charger or inductive charger, wherein the docking station 50 is inductively coupled to the power source of the toothbrush 10 and transfers energy thereto via an electromagnetic field created therebetween, thereby charging the toothbrush 10. Once the handle 15 is inserted into the docking station 50 the docking station 50 would begin to charge the power source of the toothbrush so long as the power cord 60 is plugged into a wall outlet. In yet another embodiment, the power source comprises one or more standard non-rechargeable batteries that are replaceable upon depletion and the docking station 50 serves merely as a toothbrush holder.

In the depicted embodiment, the power switch 30 comprises a depressible on/off switch, wherein depression of the switch activates the actuator and rotationally drives the brush head 25, wherein the actuator rotates the brush head and the tooth cleaning bristles 35 thereon, such that they may create a centripetal force to remove food, plaque, and other particles from teeth when applied thereto. In another embodiment, the power switch 30 comprises a slidable on/off switch, wherein sliding the switch into an on position drives the brush head 25 and sliding the switch into an off position halts the brush head 25. In yet another embodiment, the power switch 30 comprises two buttons, wherein a first button is an on switch, which activates the power source and drives the brush head 25, and a second button is an off switch, which deactivates the power source and halts the brush head 25. In yet another embodiment, the power switch 30 comprises a capacitive touch sensor, wherein the capacitive touch sensor is configured to sense a finger thereon, thereby activating the power source and driving the brush head 25 upon the sensing of a finger and halting the brush head 25 when a finger is removed therefrom.

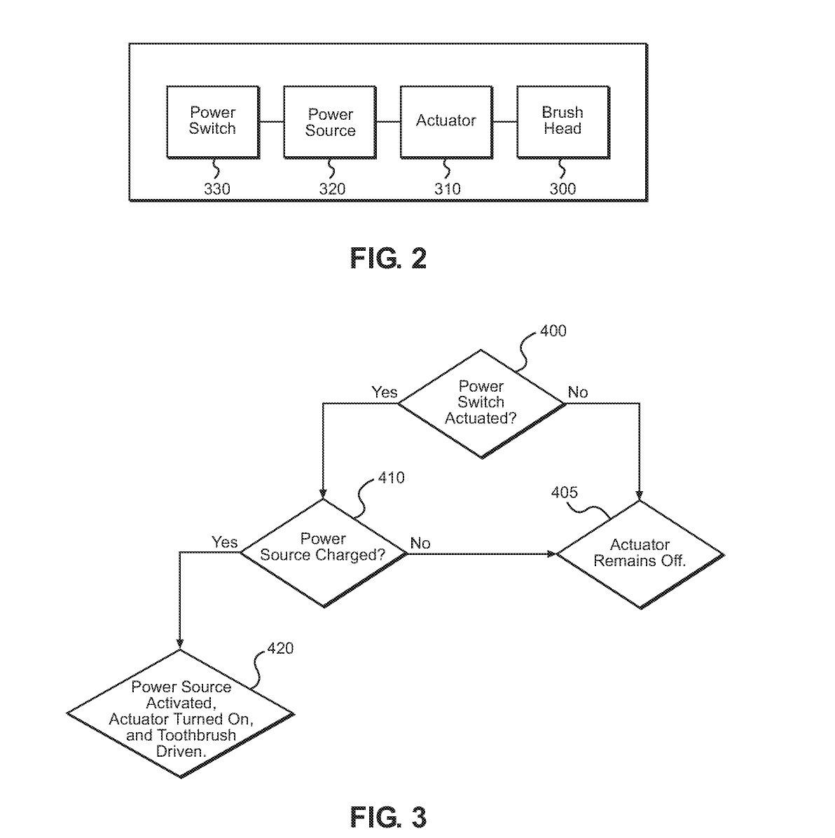

Referring now to FIGS. 2 and 3, there is shown a diagram illustrating the relationship in between the brush head and actuator and a flow chart illustrating the actuation of the instructional toothbrush, respectively. The brush head 300 is operably coupled to the actuator 310, which in turn is operably coupled to the power source 320, which is activated by actuation of the power switch 330. If the power switch 330 remains unactuated, then the actuator remains off 405. If the power source 320 is charged, actuation of power switch 400 activates the power source 420 and the actuator 310 is turned on. Once the actuator 310 is turned on, the brush head 300 is driven and the tooth cleaning bristles thereon are rotated. If the power source 320 is uncharged, the actuator 310 remains off 405 despite the power switch 330 being actuated 400. Preferably, the actuator 310 comprises an electric motor housed inside the toothbrush handle, which is coupled to a gear and camshaft which in turn are coupled to the brush head 300. Actuation of the electric motor turns the gear and camshaft, which operate to rotationally drive the brush head 300 and rotate the moveable tooth cleaning bristles thereon.

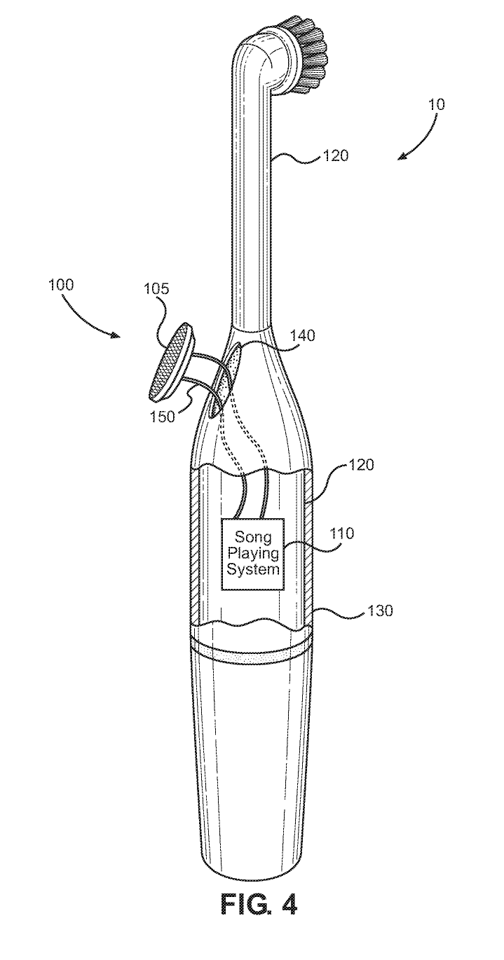

Referring now to FIG. 4, there is shown a rear perspective view of the instructional toothbrush according to one embodiment of the present invention. The one or more speakers 105 of the audio unit 100 are positioned in an opening 140 leading to an interior compartment 120 of the electric toothbrush 10, such that they are affixed thereto. The audio unit 100 is operably coupled to a song playing system 110 positioned in the interior compartment 120 of the electric toothbrush 10. The song playing system 110 is configured to sound an instructional song stored on the memory of the CPU. The song is sounded through the speakers 105 via the audio unit 100 when the toothbrush 10 is activated. The one or more speakers 105 are water-proof and configured to prevent water from breaching the interior compartment 120 of the toothbrush 10 and thereby damaging the components of song playing system 110, including the audio unit's 100 circuity 150. Further, the toothbrush 10 is composed of a water resistant material, such as plastic. In one embodiment, the plastic material is composed of polyvinyl chloride. In another embodiment, the plastic material is composed of polycarbonate. Preferably, the audio unit 100 is positioned in between the neck 120 and the handle 130 of the toothbrush 10 or in an area of the toothbrush 10 that is not directly on the gripping portion of the handle 130, such as the bottom portion of the handle. This positioning allows for optimal sound as it prevents the covering of the one or more speakers 105 by a hand when a user is brushing his or her teeth.

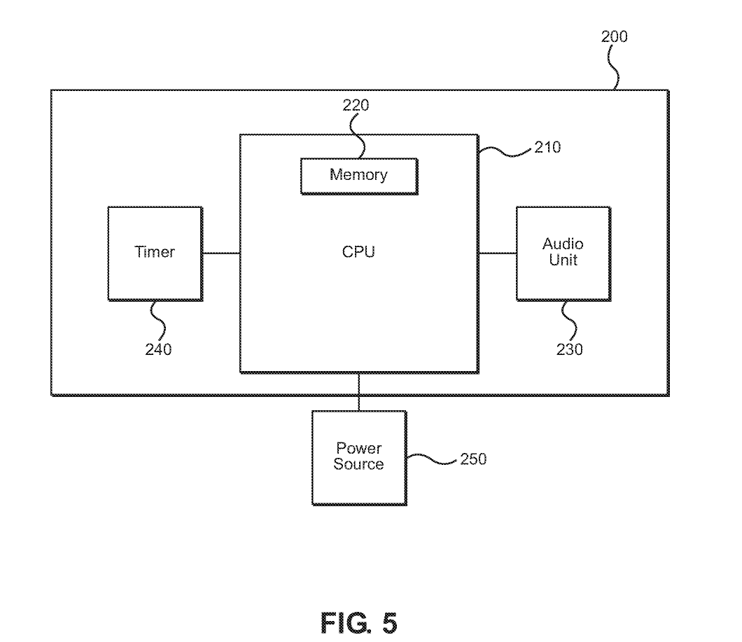

Referring now to FIG. 5, there is shown a diagram of the song playing system of the instructional toothbrush according to one embodiment of the present invention. The song playing system 200 comprises a computer processing unit (CPU) 210 having a memory 220 configured to store an instructional song that teaches a user the proper technique when brushing his or her teeth. The CPU 210 is coupled to both the power source 250 and the audio unit 230. When the power source 250 is activated the CPU 210 triggers the memory 220 to relay an electric signal to the audio unit 230 which then converts the electric signal into the audible instructional song. The song may include a variety of melodies and in one embodiment, starts with the instructional language, “start by brushing in the bottom left for the count to ten” and goes on to sing further instructions such that a user can hear and learn how to properly brush their teeth. Once the instructional song has finished, the CPU is configured to repeat the song, such that the instructions are reiterated and reinforced on a user for learning purposes.

The CPU 210 may be a general-purpose or specific-purpose processor or microcontroller. The memory 220 is a storage medium and may include one or more internally fixed storage units, removable storage units, and/or remotely accessible storage units. Also, the memory 220 may include any suitable combination of volatile memory and/or non-volatile memory and can be configured to store information, data, instructions, and/or software code.

The song playing system 200 further comprises a timer 240. The timer 240 is operably coupled to the CPU 210 and once the power source 250 is activated, the CPU 210 sends a single to the timer 240 to activate. Once the timer 240 is activated it is configured to stop the instructional song once a predetermined period of time has elapsed. The timer 240 sends a stop signal to the CPU 210 which halts the relaying of the song from the memory 220 to the audio unit 230. In one embodiment, the CPU 210 is further configured to stop the operation of the actuator once it has received the stop signal from the timer 240, thereby stopping the brush head, such that the bristles stop moving.

The American Dental Association (ADA) strongly advises that individuals brush their teeth for two minutes to prevent the formation of cavities and the like. Therefore, the timer 240 serves as a reminder to a user to brush his or her teeth for two minutes and at the same time enables the instructional song to repeat until the recommended two minutes have elapsed, thereby reinforcing the important tooth brushing instructions and technique to a user while brushing his or her teeth over time. Having a timer configured to perform this function not only helps reinforce proper tooth brushing technique by enabling an instructional song to play on repeat for two minutes, but also encourages a user to makes sure he or she brushes his teeth for the ADA recommended two minutes.

In operation, when a user actuates the power switch the CPU 210 simultaneously sends a signal to the timer 240, thereby starting the two minute countdown, and a signal to the CPU 210 which relays the instructional song stored on the memory 220 to the audio unit 230, such that the audio unit 230 can turn the relayed signal to an audible sound. Once the instructional song beings to play, it will repeat until the timer 240 sends the stop signal to the CPU 210 upon the two minutes elapsing. In this way, children brushing their teeth to the instructional song can be provided guidance on how to properly brush their teeth for the ADA recommended time period of two minutes and be further directed to stop brushing their teeth after two minutes.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An instructional toothbrush, comprising:
a handle integrally affixed to a brush neck forming a water-impermeable toothbrush body;
a brush head positioned on the brush neck, wherein the brush head comprises moveable bristles thereon;
an interior compartment positioned within the toothbrush body, comprising;
a power source;
an audio unit having one or more speakers configured to sound an instructional song upon activation of the power source;
a computer processing unit having a memory configured to store the instructional song thereon, wherein the computer processing unit is coupled to the audio unit and configured to relay the instructional song stored on the memory to the audio unit upon activation of the power source;
a timer operably coupled to the computer processing unit, wherein the timer is configured to activate upon activation of the power source;
wherein the timer is further configured to stop the audio unit after a predetermined amount of time has elapsed;
a power switch configured to activate the power source upon actuation; and
an actuator configured to drive the brush head and rotate the tooth cleaning bristles thereon upon actuation of the power switch.

2) The instructional toothbrush of claim 1, wherein the power switch comprises a depressible button.

3) The instructional toothbrush of claim 1, wherein the power switch comprises a slidable on and off switch.

4) The instructional toothbrush of claim 1, wherein the power switch comprises a capacitive touch sensor.

5) The instructional toothbrush of claim 1, wherein the audio unit is positioned in between the handle and the brush neck.

6) The instructional toothbrush of claim 1, wherein the memory is configured to store one instructional song.

7) The instructional toothbrush of claim 1, wherein the timer stops the audio unit after two minutes have elapsed.

8) The instructional toothbrush of claim 1, wherein the timer is further configured to stop the actuator after a predetermined amount of time has elapsed.

9) The instructional toothbrush of claim 9, wherein the predetermined amount of time is two minutes.

10) The instructional toothbrush of claim 1, wherein the actuator is an electric motor comprising a gear and camshaft assembly configured to rotatably drive the brush head.

11) The instructional toothbrush of claim 1, wherein the power source is a rechargeable battery chargeable by a docking station configured to receive the handle of the toothbrush.

12) The instructional toothbrush of claim 1, wherein the brush head is removably affixed to the brush neck.
